(19) United States
(12) Patent Application Publication
(10) Pub. No.: US 2021/0147606 A1
(43) Pub. Date: May 20, 2021

(54) HEAT CURING COMPOSITIONS

(71) Applicant: Dow Global Technologies LLC, Midland, MI (US)

(72) Inventors: Luigi Pellacani, Correggio (IT); Huifeng Qian, Pearland, TX (US)

(73) Assignee: Dow Global Technologies LLC, Midland, MI (US)

(21) Appl. No.: 16/629,645

(22) PCT Filed: Aug. 29, 2018
(86) PCT No.: PCT/US2018/048470

§ 371 Date: Jan. 9, 2020

(30) Foreign Application Priority Data
Sep. 1, 2017 (IT) 102017000098410

(51) Int. Cl. C08G 18/00; C09D 11/102; C08G 18/22; C08G 18/48; C08G 18/76; C08G 59/40; C08G 59/72

(52) U.S. Cl. CPC C08G 18/003; C09D 11/102; C08G 18/222; C08G 18/4825; C08G 59/72; C08G 18/4841; C08G 18/7671; C08G 59/4028; C08G 18/4829

(57) ABSTRACT

Embodiments of the present disclosure are directed towards directed towards heat curing compositions. The heat curing compositions can include an isocyanate component, wherein the isocyanate component includes an isocyanate-polyol reaction product, an epoxy material, and a Lewis acid-amine complex, wherein the heat curing composition has an isocyanate group to epoxide group ratio from 3:1 to 20:1.

### FIELD OF DISCLOSURE

Embodiments of the present disclosure are directed towards heat curing compositions, more specifically, embodiments are directed towards heat curing compositions that include an isocyanate component, wherein the isocyanate component includes an isocyanate-polyol reaction product, an epoxy material, and a Lewis acid-amine complex, wherein the heat curing composition has an isocyanate group to epoxide group ratio from 3:1 to 20:1.

### BACKGROUND

Cured materials may be utilized for a number of applications, including composite applications, among others. Examples of composite applications include, but are not limited to long fiber injection (LFI), resin transfer molding (RTM), pultrusion, filament winding, and infusion. There is continued focus in the industry on developing new and improved curable materials and/or processes that may be utilized for a number of applications.

### SUMMARY

The present disclosure provides heat curing composition including an isocyanate component, wherein the isocyanate component includes an isocyanate-polyol reaction product; an epoxy material, wherein the heat curing composition has an isocyanate group to epoxy group equivalents ratio from 3:1 to 20:1; and a Lewis acid-amine complex.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### DETAILED DESCRIPTION

Heat curing compositions are disclosed herein. The heat curing compositions include an isocyanate component, wherein the isocyanate component includes an isocyanate-polyol reaction product; an epoxy material; and a Lewis acid-amine complex, wherein the heat curing composition has an isocyanate group to epoxy group equivalents ratio from 3:1 to 20:1. Surprisingly, utilizing the isocyanate-polyol reaction product in the heat curing compositions, can provide an advantageous reduced viscosity increase, as compared to other compositions having different isocyanate group to epoxy group equivalents ratios.

The heat curing compositions disclosed herein have one or more desirable properties. For example, the heat curing compositions are heat curable. In other words, the heat curing compositions can remain uncured, e.g., unreacted, at relatively lower temperatures, and then cure, e.g., react, at relatively higher temperatures. Because the heat curing compositions are heat curable, the compositions may advantageous be stored for a later use when curing with heat is desired. In other words, the heat curing compositions are stable at room temperature.

The heat curing compositions can have an extended pot life. As used herein, “extended pot life” refers to a pot life equal to or greater than 4 hours. This extended pot life can advantageously help provide that the heat curing compositions are workable, e.g., may be formed into various shapes and/or may be applied to a surface, for a period of time that is greater than some other compositions having a relatively shorter pot life.

The heat curing compositions can be cured to form cured products having desirable properties. For example, the cured products may have one or more desirable mechanical properties discussed further herein.

The heat curing compositions disclosed herein include an isocyanate component. As used herein, “isocyanate component” refers to a component including an isocyanate-polyol reaction product. In addition to the isocyanate-polyol reaction product, the isocyanate component may include a “neat isocyanate”. As used herein, the term “neat isocyanate” refers to an isocyanate that is not an isocyanate-polyol reaction product.

Various isocyanates may be utilized to form the isocyanate-polyol reaction product and/or be utilized as the neat isocyanate. Isocyanates may be utilized to form the isocyanate-polyol reaction product and/or be utilized as the neat isocyanate are discussed further herein.

The isocyanate may be a polyisocyanate. As used herein, “polyisocyanate” refers to a molecule having an average of greater than 1.0 isocyanate groups/molecule, e.g. an average functionality of greater than 1.0. The isocyanate can be an aliphatic polyisocyanate, a cycloaliphatic polyisocyanate, an araliphatic polyisocyanate, an aromatic polyisocyanate, or combinations thereof, for example. Examples of isocyanates include, but are not limited to, toluene 2,4-/2,6-diisocyanate (TDI), methylenediphenyl diisocyanate (MDI), Polymeric MDI, triisocyanatononane (TIN), naphthyl diisocyanate (NDI), 4,4′-diisocyanatodicyclohexylmethane, 3-isocyanatomethyl-3,3,5-trimethylcyclohexyl isocyanate (isophorone diisocyanateIIPDI), tetramethylene diisocyanate, hexamethylene diisocyanate (HDI), 2-methylpentamethylene diisocyanate, 2,2,4-trimethylhexamethylene diisocyanate (THDI), dodecamethylene diisocyanate, 1,4-diisocyanatocyclohexane, 4,4′-diisocyanato-3,3′-dimethyldicyclohexylmethane, 4,4′-diisocyanato-2,2-dicyclohexylpropane, 3-isocyanatomethyl-1-methyl-1-isocyanatocyclohexane (MCI), 1,3-diisooctylcyanato-4-methylcyclohexane, 1,3-diisocyanato-2-methylcyclohexane, and combinations thereof, among others. As well as the isocyanates mentioned above, partially modified polyisocyanates including uretdione, isocyanurate, carbodiimide, uretonimine, allophanate or biuret structure, and combinations thereof, among others, may be utilized.

The isocyanate can be polymeric. As used herein “polymeric”, in describing the isocyanate, refers to higher molecular weight homologues and/or isomers. For instance, polymeric methylene diphenyl isocyanate refers to a higher molecular weight homologue and/or an isomer of methylene diphenyl isocyanate.

As mentioned, the isocyanate can have an average functionality of greater than 1.0 isocyanate groups/molecule. For instance, the isocyanate can have an average functionality from 1.5 to 8.0. All individual values and subranges from 1.5 to 8.0 are included; for example, the isocyanate can have an average functionality from a lower limit of 1.5, 1.7, 2.0, 2.3, 2.5, 2.7, or 3.0 to an upper limit of 8.0, 7.5, 7.0, 6.7, 6.5, 6.3, 6.0, 5.7 or 5.5.

The isocyanate can have an isocyanate equivalent weight 80 g/eq to 500 g/eq. All individual values and subranges from 80 to 500 g/eq are included; for example, the isocyanate can have an isocyanate equivalent weight from a lower limit of 80, 82, 84, 90, or 100 to an upper limit of 500, 450, 400, 375, or 350 g/eq.

The isocyanate may be prepared by a known process. For instance, the polyisocyanate can be prepared by phosgenation of corresponding polyamines with formation of polycarbamoyl chlorides and thermolysis thereof to provide the polyisocyanate and hydrogen chloride, or by a phosgene-free process, such as by reacting the corresponding polyamines with urea and alcohol to give polycarbamates, and thermolysis thereof to give the polyisocyanate and alcohol, for example.

The isocyanate may be obtained commercially. Examples of commercial isocyanates include, but are not limited to, polyisocyanates under the trade names VORANATE™, such as VORANATE™ M2940 (polymeric methylene diphenyl diisocyanate), and PAPI™ available from The Dow Chemical Company, among other commercial isocyanates.

The isocyanate component may be from 50 to 95 weight percent of the heat curing composition, based upon a total weight of the heat curing composition. All individual values and subranges from 0.5 to 15 are included; for example, the isocyanate component may be from a lower limit of 50; 60, or 70 wt % to an upper limit of 95; 93; or 90 wt % of the heat curing composition based upon the total weight of the heat curing composition.

As mentioned, the heat curing compositions disclosed herein include an isocyanate-polyol reaction product. The isocyanate-polyol reaction product may be referred to as a prepolymer, e.g., an isocyanate terminated prepolymer.

The isocyanate-polyol reaction product can be formed by reacting an excess of isocyanate with polyol such that the resulting isocyanate-polyol reaction product is isocyanate terminated. As an example, a diisocyanate and a diol may be utilized such that one of the isocyanate (NCO) groups of the diisocyanate reacts with one of the OH groups of the diol; the other end of the diol reacts with another diisocyanate to provide that the resulting isocyanate-polyol reaction product has an isocyanate group on both ends. As the isocyanate-polyol reaction product is isocyanate terminated, it can react like an isocyanate. However, when compared with the isocyanate used to form the isocyanate-polyol reaction product, the isocyanate-polyol reaction product has a greater molecular weight, a higher viscosity, a lower isocyanate content by weight (NCO %), and a lower vapor pressure, one or more of which may be advantageous for a number of applications. In forming the isocyanate-polyol reaction product, the isocyanate and polyol can be reacted at an equivalent ratio that is greater than 1.1:1.0; greater than 1.5:1.0, or greater than 2.0:1.0. Other know conditions and/or components may be utilized in forming the isocyanate-polyol reaction product.

As used herein, “polyol” refers to a molecule having an average of greater than 1.0 hydroxyl groups per molecule. Various polyols may be utilized to form the isocyanate-polyol reaction product. Examples of polyols include, but are not limited to a polyester-polyols, polyether-polyols, and combinations thereof.

Polyester-polyols may be prepared from, for example, organic dicarboxylic acids having from 2 to 12 carbon atoms, including aromatic dicarboxylic acids having from 8 to 12 carbon atoms and polyhydric alcohols, including diols having from 2 to 12 carbon atoms. Examples of suitable dicarboxylic acids are succinic acid, glutaric acid, adipic acid, suberic acid, azelaic acid, sebacic acid, decanedicarboxylic acid, maleic acid, fumaric acid, phthalic acid, isophthalic acid, terephthalic acid, and the isomeric naphthalene-dicarboxylic acids. The dicarboxylic acids may be used either individually or mixed with one another. Free dicarboxylic acids may be replaced by a corresponding dicarboxylic acid derivative, for example, dicarboxylic esters of alcohols having 1 to 4 carbon atoms or dicarboxylic anhydrides. Some particular examples may utilize dicarboxylic acid mixtures including succinic acid, glutaric acid and adipic acid in ratios of, for instance, from 20 to 35:35 to 50:20 to 32 parts by weight, and adipic acid, and mixtures of phthalic acid and/or phthalic anhydride and adipic acid, mixtures of phthalic acid or phthalic anhydride, isophthalic acid and adipic acid or dicarboxylic acid mixtures of succinic acid, glutaric acid and adipic acid and mixtures of terephthalic acid and adipic acid or dicarboxylic acid mixtures of succinic acid, glutaric acid and adipic acid. Examples of dihydric and polyhydric alcohols are ethanediol, diethylene glycol, 1,2- and 1,3-propanediol, dipropylene glycol, 1,4-butanediol, 1,5-pentanediol, 1,6-hexanediol, 1,10-decanediol, glycerol, trimethylolpropane, among others. Some particular examples provide that ethanediol, diethylene glycol, 1,4-butanediol, 1,5-pentanediol, 1,6-hexanediol or mixtures of at least two of said diols, in particular mixtures of 1,4-butanediol, 1,5-pentanediol and 1,6-hexanediol. Furthermore, polyester-polyols made from lactones, e.g., ε-caprolactone or hydroxycarboxylic acids, e.g., ω-hydroxycaproic acid and hydrobenzoic acid, may also be employed.

Some embodiments of the present disclosure provide that polyester-polyols may be prepared by polycondensing the organic, e.g., aliphatic and preferably aromatic polycarboxylic acids and mixtures of aromatic and aliphatic polycarboxylic acids, and/or derivatives thereof, and polyhydric alcohols without using a catalyst or in the presence of an esterification catalyst, in an inert gas atmosphere, e.g., nitrogen, carbon monoxide, helium, argon, inter alia, in the melt at from about 150 to about 250° C., at atmospheric pressure or under reduced pressure until a desired acid number, which can be less than 10, e.g., less than 2, is reached. Some embodiments of the present disclosure provide that the esterification mixture is polycondensed at the above mentioned temperatures under atmospheric pressure and subsequently under a pressure of less than 500 millibar, e.g., from 50 to 150 mbar, until an acid number of from 80 to 30, e.g., from 40 to 30, has been reached. Examples of suitable esterification catalysts include, but are not limited to, iron, cadmium, cobalt, lead, zinc, antimony, magnesium, titanium and tin catalysts in the form of metals, metal oxides or metal salts. Polycondensation may also be carried out in a liquid phase in the presence of diluents and/or entrainers, e.g., benzene, toluene, xylene or chlorobenzene, for removal of the water of condensation by azeotropic distillation, for instance.

Polyester-polyols can be prepared by polycondensing organic polycarboxylic acids and/or derivatives thereof with polyhydric alcohols in a molar ratio of from 1:1 to 1:1.8, e.g., from 1:1.05 to 1:1.2, for instance.

Anionic polymerization may be utilized, e.g., when preparing polyether polyols. For instance, alkali metal hydroxides such as sodium hydroxide or potassium hydroxide, or alkali metal alkoxides, such as sodium methoxide, sodium ethoxide, potassium ethoxide or potassium isopropoxide as catalyst and with addition of at least one initiator molecule containing from 2 to 8 reactive hydrogen atoms in bound form or by cationic polymerization using Lewis acids, such as antimony pentachloride, boron fluoride etherate, inter alia, or bleaching earth as catalysts, from one or more alkylene oxides having from 2 to 4 carbon atoms in the alkylene moiety may be utilized.

Examples of suitable alkylene oxides include, but are not limited to, tetrahydrofuran, 1,3-propylene oxide, 1,2- and 2,3-butylene oxide, styrene oxide and preferably ethylene oxide and 1,2-propylene oxide. The alkylene oxides may be used individually, alternatively one after the other, or as mixtures. Examples of suitable initiator molecules include, but are not limited to, water, organic dicarboxylic acids such as succinic acid, adipic acid, phthalic acid and terephthalic acid, and a variety of amines, including but not limited to aliphatic and aromatic, unsubstituted or N-mono-, N,N- and N,N′-dialkyl-substituted diamines having from 1 to 4 carbon atoms in the alkyl moiety, such as unsubstituted or mono- or dialkyl-substituted ethylenediamine, diethylenetriamine, triethylenetetramine, 1,3-propylene-diamine, 1,3- and 1,4-butylene diamine, 1,2-, 1,3-, 1,4-, 1,5- and 1,6-hexamethylenediamine, aniline, cyclohexanediamine, phenylenediamines, 2,3-, 2,4-, 3,4- and 2,6-tolylenediamine and 4,4′-, 2,4′- and 2,2′-diaminodiphenylmethane. Other suitable initiator molecules include alkanolamines, e.g., ethanolamine, N-methyl- and N-ethylethanolamine, dialkanolamines, e.g., diethanolamine, N-methyl- and N-ethyldiethanolamine, and trialkanolamines, e.g., triethanolamine, and ammonia, and polyhydric alcohols, in particular dihydric and/or trihydric alcohols, such as ethanediol, 1,2- and 1,3-propanediol, diethylene glycol, dipropylene glycol, 1,4-butanediol, 1,6-hexanediol, glycerol, trimethylolpropane, pentaerythritol, sorbitol and sucrose, polyhydric phenols, for example, 4,4′-dihydroxydiphenylmethane and 4,4′-dihydroxy-2,2-diphenylpropane, resols, for example, oligomeric products of the condensation of phenol and formaldehyde, and Mannich condensates of phenols, formaldehyde and dialkanolamines, and melamine.

One or more embodiments of the present disclosure provide that the polyol can include polyether-polyols prepared by anionic polyaddition of at least one alkylene oxide, e.g., ethylene oxide or 1,2-propylene oxide or 1,2-propylene oxide and ethylene oxide, onto, as initiator molecule, at least one aromatic compound containing at least two reactive hydrogen atoms and containing at least one hydroxyl, amino and/or carboxyl group. Examples of initiator molecules include aromatic polycarboxylic acids, for example, hemimellitic acid, trimellitic acid, trimesic acid and preferably phthalic acid, isophthalic acid and terephthalic acid, or mixtures of at least two polycarboxylic acids, hydroxycarboxylic acids, for example, salicylic acid, p- and m-hydroxybenzoic acid and gallic acid, aminocarboxylic acids, for example, anthranilic acid, m- and p-aminobenzoic acid, polyphenols, for example, resorcinol, and according to one or more embodiments of the present disclosure, dihydroxydiphenylmethanes and dihydroxy-2,2-diphenylpropanes, Mannich condensates of phenols, formaldehyde and dialkanolamines, preferably diethanolamine, and aromatic polyamines, for example, 1,2-, 1,3- and 1,4-phenylenediamine, e.g., 2,3-, 2,4-, 3,4- and 2,6-tolylenediamine, 4,4′-, 2,4′- and 2,2′-diamino-diphenylmethane, polyphenyl-polymethylene-polyamines, mixtures of diamino-diphenylmethanes and polyphenyl-polymethylene-polyamines, as formed, for example, by condensation of aniline with formaldehyde, and mixtures of at least two polyamines.

Examples of hydroxyl-containing polyacetals include compounds which may be prepared from glycols, such as diethylene glycol, triethylene glycol, 4,4′-dihydroxyethoxydiphenyldimethylmethane, hexanediol and formaldehyde. Suitable polyacetals can also be prepared by polymerizing cyclic acetals.

Examples of hydroxyl-containing polycarbonates can be prepared, for example, by reacting diols, such as 1,3-propanediol, 1,4-butanediol and/or 1,6-hexanediol, diethylene glycol, triethylene glycol or tetraethylene glycol, with diaryl carbonates, e.g., diphenyl carbonate, or phosgene.

Commercially available polyols may also be utilized. Examples of commercially available polyols include, but are not limited to, polyols under the trade names VORANOL™, such as VORANOL™ 8000LM, VORANOL™ 230-238, VORANOL™ 4000LM, VORANOL™ 1010L, and VORANOL™ 230-660; TERCAROL™; and VORATEC™; as well as Polyglycol P2000 and Polyglycol P425, all available from the Dow Chemical Company, among other commercially available polyols.

Polyols utilized to form the isocyanate-polyol reaction product can have a number average molecular weight from 200 g/mol to 15,000 g/mol. For example, the polyol can have a number average molecular weight from a lower limit of 200; 250; 300; 350; or 400 g/mol to an upper limit of 15,000; 12,500; 10,000; or 9,000 g/mol.

Suitable polyols can have nominal hydroxyl functionality greater than one. For example, suitable polyols can have a nominal hydroxyl functionality from a lower limit of 1.5; 1.6; 1.7; 2.0; 2.2; 2.5; or 3.0 g/mol to an upper limit of 8.0; 7.0; 6.0; 5.7; 5.5; 5.3; or 5.0.

The isocyanate-polyol reaction product can have a % NCO from 8.0% to 50.0%. All individual values and subranges from 8.0% to 50.0% are included; for example, the isocyanate-polyol reaction product can have a % NCO from a lower limit of 8.0, 8.5, 9.0, 9.5, 10.0, or 11.0% to an upper limit of 50.0, 45.0, 40.0, 35.0, 33.0, or 30.0%. % NCO of the isocyanate-polyol reaction product may be determined as a quotient, multiplied by 100%, of mass of unreacted NCO and total mass of the isocyanate-polyol reaction product, i.e., % NCO=((mass of unreacted NCO)/(total mass of the isocyanate-polyol reaction product))×100%. % NCO may be determined according to ASTM D5155.

As mentioned, the heat curing compositions are disclosed herein include an epoxy material, which may also be referred to as an epoxy resin. As used herein, the term “epoxy material” refers to a material having an average of 1.0 or more epoxy (oxirane) groups per molecule, e.g. an average functionality of 1.0 or more. The epoxy material can be an aromatic epoxy material, an alicyclic epoxy material, an aliphatic epoxy material, a heterocyclic epoxy material, or a combination thereof. Illustrative examples of epoxy materials useful herein are described in The Handbook of Epoxy Resins by H. Lee and K. Neville, published in 1967 by McGraw-Hill, New York.

Examples of aromatic epoxy materials include, but are not limited to, divinylarene dioxide, glycidyl ether compounds of polyphenols, such as hydroquinone, resorcinol, bisphenol A, bisphenol F, 4,4′-dihydroxybiphenyl, phenol novolac, cresol novolac, trisphenol (tris-(4-hydroxyphenyl)methane), 1,1,2,2-tetra(4-hydroxyphenyl)ethane, tetrabromobisphenol A, 2,2-bis(4-hydroxyphenyl)-1,1,1,3,3,3-hexafluoropropane, and 1,6-dihydroxynaphthalene.

Examples of alicyclic epoxy materials include, but are not limited to, polyglycidyl ethers of polyols having at least one alicyclic ring, or compounds including cyclohexene oxide or cyclopentene oxide obtained by epoxidizing compounds including a cyclohexene ring or cyclopentene ring with an oxidizer. Some particular examples include, but are not limited to, hydrogenated bisphenol A diglycidyl ether; 3,4-epoxycyclohexylmethyl-3,4-epoxycyclohexyl carboxylate; 3,4-epoxy-1-methylcyclohexyl-3,4-epoxy-1-methylhexane carboxylate; 6-methyl-3,4-epoxycyclohexylmethyl-6-methyl-3,4-epoxycyclohexane carboxylate; 3,4-epoxy-3-methylcyclohexylmethyl-3,4-epoxy-3-methylcyclohexane carboxylate; 3,4-epoxy-5-methylcyclohexylmethyl-3,4-epoxy-5-methylcyclohexane carboxylate; bis(3,4-epoxycyclohexylmethyl)adipate; methylene-bis(3,4-epoxycyclohexane); 2,2-bis(3,4-epoxycyclohexyl)propane; dicyclopentadiene diepoxide; ethylene-bis(3,4-epoxycyclohexane carboxylate); dioctyl epoxyhexahydrophthalate; and di-2-ethylhexyl epoxyhexahydrophthalate.

Examples of aliphatic epoxy materials include, but are not limited to, polyglycidyl ethers of aliphatic polyols or alkylene-oxide adducts thereof, polyglycidyl esters of aliphatic long-chain polybasic acids, homopolymers synthesized by vinyl-polymerizing glycidyl acrylate or glycidyl methacrylate, and copolymers synthesized by vinyl-polymerizing glycidyl acrylate or glycidyl methacrylate and other vinyl monomers. Some particular examples include, but are not limited to glycidyl ethers of polyols, such as 1,4-butanediol diglycidyl ether; 1,6-hexanediol diglycidyl ether; a triglycidyl ether of glycerin; a triglycidyl ether of trimethylol propane; a tetraglycidyl ether of sorbitol; a hexaglycidyl ether of dipentaerythritol; a diglycidyl ether of polyethylene glycol; and a diglycidyl ether of polypropylene glycol; polyglycidyl ethers of polyether polyols obtained by adding one type, or two or more types, of alkylene oxide to aliphatic polyols such as propylene glycol, trimethylol propane, and glycerin; and diglycidyl esters of aliphatic long-chain dibasic acids.

Examples of commercially available epoxy materials include those under the trade name D.E.R.™, such as D.E.R.™ 330, D.E.R.™ 331, and D.E.R.™ 731, available from Olin Epoxy, among other commercially available epoxy materials.

The epoxy material can have an epoxy equivalent weight from 80 g/eq to 600 g/eq. All individual values and subranges from 80 g/eq to 600 g/eq are included; for example, the epoxy material can have an epoxy equivalent weight from a lower limit of 80, 90, 100, or 110 g/eq to an upper limit of 600, 575, 550, or 500 g/eq.

The epoxy material may be from 3 to 25 weight percent of the heat curing composition, based upon a total weight of the heat curing composition. All individual values and subranges from 3 to 25 wt % are included; for example, the epoxy material may be from a lower limit of 3.0; 3.5; or 4.0 wt % to an upper limit of 25; 23; or 20 wt % of the heat curing composition based upon the total weight of the heat curing composition.

The heat curing compositions disclosed herein include a Lewis acid-amine complex, e.g., a Lewis acid-amine adduct. The Lewis acid-amine complexes have a 1:1 ratio of the Lewis acid to the amine.

The Lewis acid-amine complex includes a Lewis acid. As used herein a “Lewis acid” refers to a material that can accept an electron pair from a base. Examples of Lewis acids include, but are not limited to, boron trihalogenides, such as boron trichloride and boron trifluoride for instance.

The Lewis acid-amine complex includes an amine. Various amines may be utilized for the Lewis acid-amine complex. Examples of suitable amines include, but are not limited to, triethylamine, tri-n-butylamine, dimethylcyclohexylamine, N,N,N′,N′-tetramethylethylenediamine, and N,N-dimethylbenzylamine. One or more embodiments of the present disclosure provide that a tertiary amine is utilized for the Lewis acid-amine complex.

One or more embodiments of the present disclosure provide that the Lewis acid-amine complex is a boron trichloride-N,N-dimethyloctylamine complex. The boron trichloride-N,N-dimethyloctylamine complex can be represented by the following formula:

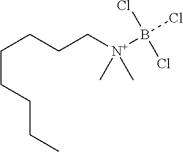

One or more embodiments of the present disclosure provide that the Lewis acid-amine complex is a boron trihalide-amine complex that can be represented by the following formulas:

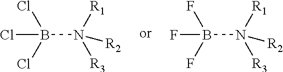

where each R₁, R₂, and R₃ are independently from hydrogen and C₁-C₁₈ alkyls.

The Lewis acid-amine complex can be prepared by known processes utilizing known components. Examples of commercially available Lewis acid-amine complex include a number of accelerators, such as DY 9577 available from Hunstman, among others.

The Lewis acid-amine complex may be from 0.5 to 15 weight percent of the heat curing composition, based upon a total weight of the heat curing composition. All individual values and subranges from 0.5 to 15 are included; for example, the Lewis acid-amine complex may be from a lower limit of 0.5; 0.7, or 1.0 wt % to an upper limit of 15; 13; or 12 wt % of the heat curing composition based upon the total weight of the heat curing composition.

The heat curing compositions disclosed herein may include a polyol having a number average molecular weight that is equal to or greater than 700 g/mol. For example, the polyol can have a number average molecular weight from a lower limit of 700; 800; 900; 1,000; or 1,500 g/mol to an upper limit of 15,000; 12,500; 10,000; or 9,000 g/mol. The polyol that may be included in the heat curing compositions can be a polyol as discussed herein regarding the isocyanate-polyol reaction product, provided that the polyol has a number average molecular weight that is equal to or greater than 700 g/mol.

The polyol having a number average molecular weight that is equal to or greater than 700 g/mol may be up to 5 weight percent of the heat curing composition, based upon a total weight of the heat curing composition. For example, the polyol may be from a lower limit of 0.1; 0.3; 0.5; 0.7, or 1.0 wt % to an upper limit of 5.0; 4.5; 4.0; 3.5, or 3.0 wt % of the heat curing composition based upon the total weight of the heat curing composition.

The heat curing compositions can include an additive. Examples of additives include, but are not limited to co-catalysts; de-molding agents; solvents; fillers; pigments; toughening agents; flow modifiers; adhesion promoters; diluents; stabilizers; plasticizers; catalyst de-activators; flame retardants, and combinations thereof, among others. Various amounts of the additive may be utilized for different applications.

The heat curing compositions have an isocyanate group to epoxy group equivalents ratio from 3:1 to 20:1. All individual values and subranges from 3:1 to 20:1 are included; for example, the heat curing composition can have an isocyanate group to epoxy group equivalents ratio from a lower limit of 3:1, 3.5:1 or 4:1 to an upper limit of 20:1, 18:1, or 15:1.

The heat curing compositions has an epoxy group to moles of Lewis acid-amine complex equivalent ratio from 1:1 to 15:1. All individual values and subranges from 1:1 to 15:1 are included; for example, the heat curing composition can have an epoxy group to moles of Lewis acid-amine complex equivalent ratio from a lower limit of 1:1, 1.3:1, or 1.5:1 to an upper limit of 15:1, 12:1, or 10:1.

One or more embodiments of the present disclosure provide that the heat curing compositions may be utilized with a reinforcement material. For example, glass may be utilized as fibers or mats; also carbon fibers and/or aramid fibers may be utilized among others. When utilized, the fibers may be chopped and/or aligned, for instance.

As mentioned, the heat curing compositions advantageously are stable at room temperature, e.g., approximately 20° C. The heat curing compositions can be stable at 20° C. for 6 hours to 14 days. All individual values and subranges from 6 hours to 14 days are included; for example, the heat curing composition can have be stable at 20° C. from a lower limit of 6 hours, 9 hours, 12 hours, 18 hours, or 24 hours to an upper limit of 14 days, 12 days, 10 days, 9 days, or 7 days. Stability at room temperature, can be determined by various known techniques. As used herein, “stability” refers to usability of the heat curing composition. For instance, after a certain number of hours or days at 20° C., the heat curing composition is stable if the heat curing composition can be cured to form a cured product. Stability implies that the viscosity will not have substantially changed, and that the heat curing composition will still polymerize as desired after exposure to heat. It is noted that the above definition of stability does not refer to the relatively slow reaction between isocyanate that is present in the heat curing composition and the moisture that may be present in the atmosphere.

As mentioned, the heat curing compositions advantageously have an extended pot life. The heat curing compositions can have a pot life from equal to or greater than 4 hours to 48 hours. All individual values and subranges from 4 hours to 48 hours are included; for example, the heat curing composition can have a pot life from a lower limit of 4, 6, 12, 15, 18, or 24 hours to an upper limit of 48, 40, 36, 34, 32, or 30 hours. Pot life can be described as an amount of time that it takes for an initial mixed viscosity to double. For instance, a composition having a particular initial viscosity at room temperature (23° C.), e.g., a viscosity <1000 millipascal-second (mPas), can have a pot life that is measured as an interval from a moment composition mixing begins to a moment the composition has a viscosity that is doubled relative to the particular initial viscosity. Viscosity can be measured at a prescribed temperature, as described in ASTM D4287, for instance.

As mentioned, the heat curing compositions can remain uncured, e.g., unreacted, at relatively lower temperatures, and then cure, e.g., react, at relatively higher temperatures, which may be referred to as an onset temperature. The heat curing compositions can have an onset temperature from 80° C. to 150° C. All individual values and subranges from 80° C. to 150° C. are included; for example, the heat curing composition can have an onset temperature from a lower limit of 80, 85, 90, 95, or 100° C. to an upper limit of 150, 147, 145, 143, or 140° C.

The heat curing compositions can cure to form cured products upon exposure to the onset temperature. For instance, the curing may be essentially completed in a period from 10 seconds to 10 minutes. Curing, e.g., heating, the heat curing compositions can be performed via a number of processes, such as pultrusion, filament winding, long fiber injection (LFI), resin transfer molding (RTM), infusion, and sheet moulding compound (SMC), among others.

The cured products may have one or more desirable mechanical properties, which may be advantageous for a number of applications. For instance, the cured product may be utilized for a number of articles, such as composites, coatings, adhesives, inks, encapsulations, and castings, among others.

The cured product may have a glass transition temperature equal to or greater than 150° C. For example, the cured product may have a glass transition temperature from a lower limit of 150; 155; 160; 170; or 175° C. to an upper limit of 270; 265; 260; 255; or 250° C. One or more embodiments provide that the cured product may has a glass transition temperature equal to or greater than 200° C.

The cured product may have a flexural strength equal to or greater than 30 MPa. For example, the cured product may have a flexural strength from a lower limit of 30; 33; or 35 MPa or to an upper limit of 150; 140; or 130 MPa.

The cured product may have a flexural strain equal to or greater than 2%. For example, the cured product the polyol may have a flexural strain from a lower limit of 2.0; 2.3; or 2.5% or to an upper limit of 10; 9; or 8%.

The cured product may have a flexural modulus equal to or greater than 1200 MPa. For example, the cured product may have a flexural modulus from a lower limit of 1200; 1250; or 1300 MPa or to an upper limit of 4000; 3000; or 2800 MPa.

### Examples

In the Examples, various terms and designations for materials are used including, for instance, the following:

Isocyanate component (isocyanate-polyol reaction product; VORAIVIER™ RF1024; methylene diphenyl diisocyanate/polymeric isocyanate-propylene oxide diol/ethylene oxide capped triol reaction product; % NCO approximately 14.5-15.2%; available from The Dow Chemical Company); isocyanate component (neat isocyanate; VORANATE™ M2940; polymeric methylene diphenyl diisocyanate; average functionality of 2.4-2.5; isocyanate equivalent weight 132 g/eq; available from The Dow Chemical Company); epoxy material (D.E.R.™ 330; bisphenol A epoxy resin; epoxy equivalent weight of 176-185 g/eq; available from Olin Epoxy); Lewis acid-amine complex (DY 9577; boron trichloride-amine complex, available from Hunstman); internal mold release (INT-PUL-24; available from Axel Plastics Research Laboratories Inc.); epoxy material (D.E.R.™ 331; bisphenol A epoxy resin; epoxy equivalent weight of 182-192 g/eq; available from Olin Epoxy); epoxy material (D.E.R.™ 731; 1,4-butanediol diglycidyl ether; epoxy equivalent weight of 130-145 g/eq; available from Olin Epoxy); polyol (VORANOL™ 8000LM; propylene glycol-initiated polyether polyol, nominal hydroxyl functionality 2; number average molecular weight 8,000 g/mol; available from The Dow Chemical Company); ISOCYANATE™ 30 OP (methylene diphenyl diisocyanate with 30% 2,4-MIDI; available from The Dow Chemical Company); polyol (VORANOL™ P2000; propylene oxide diol; equivalent weight 1,000 g/eq; available from The Dow Chemical Company); polyol (VORANOL™ CP 6001; ethylene oxide capped triol; equivalent weight 2,000 g/eq; available from The Dow Chemical Company).

Isocyanate component-lab synthesized (isocyanate-polyol reaction product) was prepared as follows. 785.6 g of ISOCYANATE™ 50 OP (methylene diphenyl diisocyanate with 50% 2,4-NIDI; available from The Dow Chemical Company) and 214.4 g of VORANOL™ 230-238 (glycerine initiated polyether polyol; nominal hydroxyl functionality 3; number average molecular weight 700 g/mol; available from The Dow Chemical Company) were added to a flask under nitrogen the contents of the flask were heated at approximately 75-80° C. for 2 hr to form the isocyanate component-lab synthesized, having a % NCO of approximately 22.5%.

The % NCO (isocyanate content) was determined according to ASTM D5155 (standard test method for polyurethane raw materials: determination of the isocyanate content of aromatic isocyanates—method C) using a Mettler DL55 autotitrator equipped with two titration stands, two solvent pumps and an autosampler carousel. Samples were dissolved in trichlorobenzene and mixed with an excess of dibutylamine in toluene and stirred for 20 minutes, then diluted with methanol, and thereafter titrated potentiometrically with standardized 1.0 N hydrochloric acid (aqueous) using a 20 mL burette. A blank analysis was performed, in duplicate, using the method described above but without adding the sample. The average of the blank analysis was used to calculate the % NCO using the following formula:

$$\% NCO = \frac{( B - S ) N \times 4.202}{W}$$

where B is volume in mL of acid consumed by blank (duplicate average), S is the volume in mL of acid consumed by sample, N is the normality of acid, 4.202 is the equivalent weight of the isocyanate (NCO) moiety adjusted for conversion to percent, and W is the weight in g of the sample.

Examples 1-10, heat curing compositions, were prepared as follows. For each Example, the items listed in Table 1 and Table 2 were combined in a respective container by mixing.

Comparative Examples A-D were prepared as Examples 1-10, with the change that the items listed in Table 3 were utilized rather than the items listed in Table and Table 2.

TABLE 1

| | Example | Example | Example | Example | Example |
|---|---|---|---|---|---|
| | 1 | 2 | 3 | 4 | 5 |
| VORAMER ™ | 40 g | 40 g | 40 g | 40 g | 40 g |
| RF1024 | | | | | |
| (isocyanate | | | | | |
| component) | | | | | |
| VORANATE ™ | 60 g | 60 g | 60 g | 60 g | 60 g |
| M2940 | | | | | |
| (isocyanate | | | | | |
| component) | | | | | |
| DY 9577 | 6 g | 3 g | 9 g | 3 g | 9 g |
| (Lewis acid- | | | | | |
| amine complex) | | | | | |
| D.E.R. ™ 330 | 18 g | 9 g | 27 g | 21 g | 15 g |
| (epoxy material) | | | | | |
| INT-PUL-24 | 2 g | 2 g | 2 g | 2 g | 2 g |
| (internal mold | | | | | |
| release) | | | | | |
| OH/NCO | 0 | 0 | 0 | 0 | 0 |
| equivalents ratio | | | | | |
| isocyanate group to | 6.0:1 | 12.0:1 | 4.0:1 | 5.0:1 | 7.0:1 |
| epoxy group | | | | | |
| equivalents ratio | | | | | |
| Epoxy group to | 4.5:1 | 4.5:1 | 4.5:1 | 10.5:1 | 2.5:1 |
| moles Lewis acid- | | | | | |
| amine complex | | | | | |
| equivalent ratio | | | | | |
| wt % isocyanate | 79.37% | 87.72% | 72.46% | 79.37% | 79.37% |
| component | | | | | |
| wt % epoxy material | 14.29% | 7.89% | 19.57% | 16.67% | 11.90% |
| wt % Lewis acid-amine | 4.76% | 2.63% | 6.52% | 2.38% | 7.14% |
| complex | | | | | |
| wt % polyol | — | — | — | — | — |

TABLE 2

| | Example | Example | Example | Example | Example |
|---|---|---|---|---|---|
| | 6 | 7 | 8 | 9 | 10 |
| VORAMER ™ | 40 g | 50 g | 30 g | — | — |
| RF1024 | | | | | |
| (isocyanate | | | | | |
| component) | | | | | |
| VORANATE ™ | 60 g | 50 g | 70 g | — | — |
| M2940 | | | | | |
| (isocyanate | | | | | |
| component) | | | | | |
| Isocyanate | — | — | — | 88 g | 88 g |
| compound-lab | | | | | |
| synthesized | | | | | |
| (isocyanate | | | | | |
| component) | | | | | |
| DY 9577 | 12 g | 6 g | 6 g | 2 g | 2 g |
| (Lewis acid- | | | | | |
| amine complex) | | | | | |
| D.E.R. ™ 330 | 12 g | 18 g | 18 g | — | — |
| (epoxy material) | | | | | |
| D.E.R. ™ 331 | — | — | — | 8.3 g | — |
| (epoxy material) | | | | | |
| D.E.R. ™ 731 | — | — | — | — | 6 g |
| (epoxy material) | | | | | |
| VORANOL ™ | — | — | — | 17 g | 17 g |
| 8000LM | | | | | |
| (polyol) | | | | | |
| INT-PUL-24 | 2 g | 2 g | 2 g | — | — |
| (internal mold | | | | | |
| release) | | | | | |
| OH/NCO | — | — | — | 0.00091:1 | 0.00091:1 |
| equivalents ratio | | | | | |
| isocyanate group to | 9.0:1 | 5.5:1 | 6.4:1 | 10.8:1 | 10.2:1 |
| epoxy group | | | | | |
| equivalents ratio | | | | | |
| Epoxy group to | 1.5:1 | 4.5:1 | 4.5:1 | 6.3:1 | 6.7:1 |
| moles Lewis acid- | | | | | |
| amine complex | | | | | |
| equivalent ratio | | | | | |
| wt % isocyanate | 79.37% | 79.37% | 79.37% | 88.10% | 88.10% |
| component | | | | | |
| wt % epoxy material | 9.52% | 14.29% | 14.29% | 8.29% | 6.00% |
| wt % Lewis acid-amine | 9.52% | 4.76% | 4.76% | 1.90% | 1.90% |
| complex | | | | | |
| wt % polyol | — | — | — | 1.71% | 1.71% |

TABLE 3

| | Comparative | Comparative | Comparative | Comparative |
|---|---|---|---|---|
| | Example A | Example B | Example C | Example D |
| ISOCYANATE ™ | — | — | — | 5.4 g |
| 30 OP | | | | |
| (isocyanate | | | | |
| component) | | | | |
| VORAMER ™ | — | — | — | 20 g |
| RF1024 | | | | |
| (isocyanate | | | | |
| component) | | | | |
| Isocyanate | 88 g | 88 g | 88 g | — |
| compound-lab | | | | |
| synthesized | | | | |
| (isocyanate | | | | |
| component) | | | | |
| VORANATE ™ | — | — | — | 59.6 g |
| M2940 | | | | |
| (isocyanate | | | | |
| component) | | | | |
| Propylene oxide | — | — | — | 15 g |
| diol/ethylene | | | | |
| oxide capped triol | | | | |
| (1:3 ratio) | | | | |
| VORANOL ™ 8000LM | 17 g | 17 g | 17 g | — |
| (polyol) | | | | |
| DY 9577 | — | 1.9 g | — | 6 g |
| (Lewis acid- | | | | |
| amine complex) | | | | |
| D.E.R. ™ 330 | — | — | — | 18 g |
| (epoxy material) | | | | |
| D.E.R. ™ 331 | — | — | 8.3 g | — |
| (epoxy material) | | | | |
| INT-PUL-24 | — | — | — | 2 g |
| (internal mold | | | | |
| release) | | | | |
| OH/NCO | 0.00091:1 | 0.00091:1 | 0.00091:1 | 0.02:1 |
| equivalents ratio | | | | |
| isocyanate group | — | — | 10.8:1 | 1.15:1 |
| to epoxy group | | | | |
| equivalents ratio | | | | |
| Epoxy group to | — | — | — | 4.55:1 |
| moles Lewis acid- | | | | |
| amine complex | | | | |
| equivalent ratio | | | | |
| wt % isocyanate | 98.1% | 96.1% | 89.8% | 26.8% |
| component | | | | |
| wt % epoxy material | — | — | 8.5% | 32.1% |
| wt % Lewis acid-amine | — | 2.1% | — | 10.7% |
| complex | | | | |
| wt % polyol | 1.90% | 1.86% | 1.74% | 26.8% |

Visual observation indicated that Examples 1-10 and Comparative Examples A-D were respectively stable at room temperature for at least 6 hours as no gelation was observed.

Onset temperatures, defined as the temperature at which the polymerization reaction begins, were determined for Examples 1-10 and for Comparative Examples A-D by utilizing an AR2000 Rheometer (TA instrument) with a temperature increase of 2.5° C./min, starting from 25° C. and a shear rate of 10/s. The results are reported in Table 4.

Pot life, as used herein, refers to a period of time, at a given temperature, that a mixture of the resin component and the hardener component remains workable for a particular application. Pot lifes were determined for Examples 1-10 and for Comparative Examples A-C by utilizing an AR2000 Rheometer (TA instrument) at a temperature of 25° C. and a shear rate of 10/s; viscosities were determined as described in ASTM D4287. The results are reported in Table 4.

TABLE 4

| | Onset temperature | Pot Life |
|---|---|---|
| Example 1 | 126° C. | >24 hours |
| Example 2 | 135° C. | >24 hours |
| Example 3 | 121° C. | >24 hours |
| Example 4 | 127° C. | >24 hours |
| Example 5 | 126° C. | >24 hours |
| Example 6 | 132° C. | >24 hours |
| Example 7 | 126° C. | >24 hours |
| Example 8 | 125° C. | >24 hours |
| Example 9 | 116° C. | >24 hours |
| Example 10 | 116° C. | >24 hours |
| Comparative | No reaction | NA |
| Example A | observed | |
| Comparative | No reaction | NA |
| Example B | observed | |
| Comparative | No reaction | NA |
| Example C | observed | |

The data of Table 4 illustrates that each of Examples 1-10 are heat curing compositions having onset temperatures from 116 to 135° C.

The data of Table 4 also illustrates that Examples 1-10 have an extended pot life, each of Examples 1-10 respectively has a pot life greater than 24 hours. As discussed herein, heat curing compositions having an extended pot life can be advantageous for a number of applications.

Viscosity increase was determined utilizing an AR2000 Rheometer (TA instrument) at a temperature of 40° C. and a shear rate of 10/s for three hours. The results are reported in Table 5.

TABLE 5

| | Initial | Final | Viscosity |
|---|---|---|---|
| | viscosity | viscosity | increase |
| Example 7 | 500 mPas | 500 mPas | 0% |
| Comparative | 400 mPas | 550 mPas | 37% |
| Example D | | | |

The data of Table 5 illustrates that Example 7 had a 0% viscosity increase, while Comparative Example D had a 37% viscosity increase. The data of Table 5 indicates that compositions disclosed herein can provide an advantageous reduced viscosity increase, as compared to other compositions, i.e. compositions including greater than 5 weight percent of polyol.

This reduced viscosity increase is surprising because for Comparative Example D the amount of VORAIVIER™ RF1024 was reduced from 50 g to 20 g, as compared to Example 7; however, Comparative Example D did include 30 g of the isocyanate and polyol utilized in forming VORAMER™ RF102. As such, utilizing the isocyanate-polyol reaction product, e.g., rather than the individual components used in forming the isocyanate-polyol reaction product, can provided the advantageously reduced viscosity increase for heat curing composition having an isocyanate group to epoxy group equivalents ratio from 3:1 to 20:1.

Examples 11-19, cured products, were prepared as follows. Examples 1-9 were respectively placed into a mold and cured at 125° C. for 1 hour, and subsequently at 150° C. for hour to form Examples 11-19. The molds were each made from “U”-shaped, ⅛ inch thick aluminum spacers positioned between two sheets of Duo-foil aluminum, which were coated with a release agent and compressed between two metal plates. A rubber tubing was used for gasket material along the inside of the spacer. The molds were clamped together and the open end of the “U”-shaped spacers faced upward, with the Duo-foil extending to the edges of the metal plates.

Glass transition temperature, flexural strength, flexural strain, and flexural modulus were determined for Examples 18-19. The results are reported in Table 5. Glass transition temperatures were determined by Dynamic Mechanical Thermal Analysis (DMTA), using ASTM D4065-12 method. DMTA was measured in a TA instrument Rheometer (Model: ARES). Rectangular samples (approximately 6.35 cm×1.27 cm×0.32 cm) were placed in solid state fixtures and subjected to an oscillating torsional load. The samples were thermally ramped from approximately −80° C. to approximately 200° C. at a rate of 3° C./minute and 1 Hertz (Hz) frequency. Flexural strength, flexural strain, and flexural modulus were determined using ASTM D790, which uses a standard 16:1 span-to-thickness ratio. The samples were cut in 3 inch long bars with approximately ½ inch thickness. Tensile tests were performed using ASTM D638 (type I) method. Fracture toughness was measured according to ASTM D5045 by a screw-driven material testing machine (Instron model 5567). Compact-tension geometry was used.

TABLE 6

| | Glass | | | |
|---|---|---|---|---|
| | transition | Flexural | Flexural | Flexural |
| | temperature | strength | strain | modulus |
| Example 18 | >200° C. | 87 MPa | 4.4% | 2320 MPa |
| (formed from | | | | |
| Example 8) | | | | |
| Example 19 | >200° C. | 121 MPa | 5.6% | 2965 MPa |
| (formed from | | | | |
| Example 9) | | | | |

The data of Table 6 illustrates that cured products formed from the heat curing compositions disclosed herein have a number of advantageous properties including a high glass transition temperature, a desirable flexural strength, a desirable flexural strain, and/or a desirable flexural modulus, which can be advantageous for a number of applications.

1. A heat curing composition comprising:
an isocyanate component, wherein the isocyanate component includes an isocyanate-polyol reaction product having a % NCO from 11% to 50%;
an epoxy material, wherein the heat curing composition has an isocyanate group to epoxy group equivalents ratio from 3:1 to 20:1; and
a Lewis acid-amine complex.

2. The composition of claim 1, wherein the composition has an epoxy group to moles of Lewis acid-amine complex equivalent ratio from 1:1 to 15:1.

3. The composition of claim 1, wherein the isocyanate component includes a neat isocyanate.

4. The composition of claim 1, including a polyol having a number average molecular weight equal to or greater than 700 g/mol.

5. The heat curing composition of claim 4, wherein the polyol is equal to or less than five weight percent of the heat curing composition.

6. A cured product formed from curing the heat curing composition of claim 1.

7. An article comprising the cured product of claim 6, wherein the article is a composite, a coating, an adhesive, an ink, an encapsulation, or a casting.

8. A process for preparing a cured product comprising heating the heat curing composition of claim 1.

9. The process of claim 6, wherein heating the heat curing composition includes heating the curing composition to an onsett temperature of from 60° C. to 200° C.

10. The cured product of claim 6, wherein heating the heat curing composition includes a process selected from the group consisting of pultrusion, filament winding, long fiber injection (LFI), resin transfer molding (RTM), infusion, and sheet moulding compound (SMC).
